(19) United States
(12) Patent Application Publication
(10) Pub. No.: US 2021/0276311 A1
(43) Pub. Date: Sep. 9, 2021

(54) EXTRUSION COATED CAN LINER FILM

(71) Applicant: Toray Plastics (America), Inc., North Kingstown, RI (US)

(72) Inventors: Jan MORTIZ, North Kingstown, RI (US); Robert ERVOLINO, North Kingstown, RI (US); Gerado RADA, North Kingstown, RI (US)

(21) Appl. No.: 16/805,685

(22) Filed: Feb. 28, 2020

(51) Int. Cl. B32B 27/08; B32B 27/36; B32B 27/32; B65D 65/40

(52) U.S. Cl. CPC B32B 27/08; B32B 27/36; B32B 27/32; B65D 65/40; B32B 2439/66; B32B 2255/10; B32B 2255/26; B32B 2439/70; B32B 2270/00

(57) ABSTRACT

Embodiments relate to a multilayer film for food packaging applications, the multilayer film having chemical resistance to products having low to high pH from about 1 pH to about 13 pH, the multilayer film comprising a base layer and a top layer; wherein the base layer comprises polyethylene terephthalate, and optionally polybutylene terephthalate; and the top layer comprises low density polyethylene; wherein the multilayer film optionally has a thickness of 80 G (20 μm) or less.

### RELATED APPLICATIONS

This application is related to US Patent Publication 2018/0281367 A1, entitled “HIGH-HERMETICITY DUAL OVENABLE FOOD PACKAGING FILM,” published on Oct. 4, 2018, which is incorporated herein in its entirety.

### FIELD OF INVENTION

Embodiments are directed to a multilayer film comprising a base layer of primarily polyethylene terephthalate (PET) film, and optionally one or more layers comprising (a) amorphous polyethylene terephthalate copolymerized with isophthalic acid monomer (IPET), (b) amorphous polyethylene terephthalate copolymerized with cyclohexanedimethal (PETG), (c) a primer layer comprising polyethylene imine (PEI), (d) an extrusion coated layer comprising low molecular weight polyethylene (LDPE), and combinations thereof. The film is used in a metal lamination process where the laminated sheet is formulated into can parts that are used to contain contents of varying pH (low to high pH from 1 pH, such as that of gastric acid, to 13 pH, such as that of bleach and oven cleaner).

### BACKGROUND OF INVENTION

Food producers increasingly offer portioned, prepared foods for their customers' convenience. In these food products, the food can be already prepared, mixed, and seasoned. In some instances, the food is already cooked, leaving the customer to reheat only (if desired). In other cases, the food is provided raw and is cooked by the customer. By moving food preparation from the serving location to a centralized supplier, the customers can achieve better consistency across locations, improved efficiencies of labor and material, and reduced costs. For the food producer, higher profits can be achieved by offering value-added products.

One challenge in providing food in such a manner is the packaging of the food. There are many factors that influence the packaging format and the requirements of the materials used to form that packaging. Some of these requirements are temperatures and pressures seen by the packaging in processing, distribution, and end use; weight, type, and nature of the product; secondary packaging style; marketing considerations such as display surface and consumer perception; costs of both material and processing/packing operations; and regulatory compliance.

Metal food and beverage cans are lined on the interior surface with a protective coating, which is essential to prevent corrosion of the can and contamination of food and beverages with dissolved metals. In addition, the coating helps to prevent canned foods from becoming tainted or spoiled by bacterial contamination. The major types of interior can coating are made from epoxy resins, which have achieved wide acceptance for use as protective coatings because of their exceptional combination of toughness, adhesion, formability and chemical resistance. Such coatings are essentially inert and have been used for over 40 years. In addition to protecting contents from spoilage, these coatings make it possible for food products to maintain their quality and taste, while extending shelf life

However, these epoxy polymers may contain a residual amount of a chemical building block called BPA or Bisphenol A. which has faced much scrutiny from consumer advocacy groups. California proposed, for the second time, to list bisphenol A as a cause of reproductive toxicity under a state law called Proposition 65. Although the maximum allowable dose would be too high to require warning labels on most products, such as food cans that are lined with BPA-based epoxy resins, the proposal adds another reason that people might want to avoid the chemical.

In the past decade, consumers and health experts have raised concerns about the use of BPA in food packaging. The molecule has a shape similar to estrogens and thus may act as an endocrine disrupter. The chemical industry and makers of metal food packaging contend that BPA is safe.

For food companies pleasing consumers is a high priority and most are eager to move away from packaging coatings based on BPA. Coating manufacturers and their suppliers are working to find improved replacements for the ubiquitous epoxies, which are made by reacting BPA with epichlorohydrin.

Laminating polyester films to metal prior to forming the can parts is one solution for replacing cans lined with an epoxy coating. Polyethylene containing Biaxially oriented polyester (BOPET) films are used for multiple applications such as food packaging, decorative, and labels for example.

The food packaging industry commonly uses Polyethylene containing BOPET films in many heat sealable tray applications where direct contact of food to Polyethylene containing BOPET is common, to take advantage of the intrinsic properties of Polyethylene containing BOPET such as clarity, tensile strength, and its inert chemical composition.

Below, find excerpts from related art references.
Reference D1: US20180281367

The film of D1 is designed for food packaging. D1 teaches a biaxially oriented polyester films (PET) with heat stable base layer made of LDPE, wherein a primer layer (PEI) is applied to the heat stable base layer or skin layer.

D1 discloses dual ovenable, high-hermeticity sealable films for packaging uses, such as form-fill-and-seal packages (e.g., bags). The films disclosed herein can have hermetic seal characteristics and hot tack strength at elevated temperatures for cooking and/or reheating operations. The films disclosed herein can be made comprising a heat stable base layer (e.g., a cast, monoaxially oriented, or biaxially oriented polypropylene, polyester, or polyamide film); a heat sealable layer; and/or a lap sealable layer.

In claim 1, D1 recites a film comprising: a heat stable layer; and a heat sealable layer on a side of the heat stable layer, wherein the heat sealable layer comprises: a first heat sealable layer comprising 60-80 wt % metallocene-catalyzed polypropylene and 20-40 wt % low density polyethylene (LDPE); a second heat sealable layer on a side of the first heat sealable layer opposite the heat stable layer comprising 60-80 wt % metallocene-catalyzed polypropylene and 20-40 wt % low density polyethylene (LDPE); and a third heat sealable layer on a side of the second heat sealable layer opposite the first heat sealable layer comprising 75-95 wt % metallocene-catalyzed polypropylene and 5-25 wt % propylene-butylene copolymer.

Claim 8 of D1 recites: “The film of claim 1, wherein the heat stable layer comprises a core layer comprising crystalline PET and a skin layer on a side of the core layer opposite the heat sealable layer comprising amorphous copolyester.”

The primer layer of D1 can help ensure strong adhesion of the heat sealable layer to the heat stable layer. In some embodiments, the primer layer is formed using MICA A-131-X or MICA H-760-A. In some embodiments, the heat sealable layer can be extrusion-coated on the primer layer or on the heat stable layer.

Paragraph [0071] of D1 states, “The sealable films disclosed herein can have an overall thickness of about 100-400 G, about 200-300 G, about 225-275 G, about 240-260 G, or about 250 G.” Note that a thickness of about 100-400 G is equal to a thickness of 25-100 μm. D1 fails to teach or suggest a film for food packaging having a film thickness of 80 G (20 μm) or less.
Reference D2: KR101459275 B1

D2 discloses a multilayer film with base layer consisting of (PET) polyethylene terephthalate, polybutylene terephthalate (PBT), polyethylene terephthalate glycol (PETG) and the first film layer is made of PETG and linear low density PE (LLDPE).
Reference D3: U.S. Pat. No. 9,956,747

D3 relates to composite which includes a multilayer polyethylene terephthalate (PET) film having a base layer and an adjacent skin layer; wherein skin layer is a blend of PET and PBT.

The Abstract of D3 discloses a composite includes a multilayer polyethylene terephthalate (PET) film having a base layer and an adjacent skin layer. The PET of the skin layer has inherent viscosity of about 0.70-0.90 and carboxyl end group concentration of less than 25 eq/T. The base layer can be affixed to a thin metal sheet. Optionally, the base layer of a second multilayer PET film with a skin layer inherent viscosity of about 0.70-0.90 and carboxyl end group concentration of less than 25 eq/T can be affixed to the opposite side of the metal sheet. The composite is suited for making food and chemical containers such as food storage cans that resist blush discoloration from steam contact during container formation and age degradation during extended storage of harsh chemical products.
Reference D4: US20170152075

D4 relates to an outer release layer resin composition comprising an ultra-high molecular weight siloxane polymer and a polyethylene terephthalate resin. Embodiments in D4 relates to a Bisphenol A-free multi-layer, such as a biaxially oriented polyester (BOPET) film, for lamination on metal sheets, which could be used for food containers. The BOPET film has an outer release layer, which aids in the release of food, such as a high protein food source, when food is cooked and sterilized in direct contact with the outer release layer. The BOPET film can be laminated to metals used in the manufacture of food containers with the outer release layer being exposed to allow a direct food contact between the surface of the outer release layer and food. More particularly, the invention relates to a novel outer release layer resin composition comprising an ultra-high molecular weight siloxane polymer and a polyethylene terephthalate resin. Optionally, an alkali-metal phosphate and a phosphoric acid compound can be added, during polymerization the outer release layer resin composition, as a catalyst/additive package to the ingredients forming the outer release layer resin composition.
Reference D5: US20150122812

D5 discloses a laminated metal sheet made of polyethylene terephthalate and its copolymers. The laminated metal sheet includes a metal sheet, a first polyester resin layer, and a second polyester resin layer, and the first polyester resin layer contains 30% by mass to 60% by mass of: polyethylene terephthalate; or copolymerized polyethylene terephthalate having a copolymerization component content of less than 6 mol %; and 40% by mass to 70% by mass of polybutylene terephthalate, the second polyester resin layer is copolymerized polyethylene terephthalate having a copolymerization component content of less than 14 mol %, residual orientations of the first and second polyester resin layers are less than 20%, and film thicknesses X and Y of the first and the second polyester resin layers before forming satisfy predetermined conditions.
Reference D6: WO02/26493 A1

D6 discloses shrinkable layer comprises a copolyester comprising substantially ethylene isophthalate and ethylene terephthalate for containers used for packaging ready-prepared ovenable meals. The Abstract of D6 discloses a multi-layer laminated polymeric film comprising a substrate layer having on one side thereof a heat-sealable peelable layer and having on the opposite side thereof a shrinkable layer, wherein said shrinkable layer has a degree of shrinkage in a first dimension of about 10-80% over the temperature range 55 to 100° C., and a ratio of shrinkage at 100° C. said first dimension relative to a second, orthogonal dimension in the range of 1:1 to 1:1; a process for making the same; and the use of said film as a lid for a container, particularly a container used for packaging ready-prepared ovenable meals.

The embodiments herein relate to a multilayer film for food and non-food packaging applications, the multilayer film having chemical resistance to products having low to high pH from about 1 pH to about 13 pH, the multilayer film comprising a base layer and a top layer; wherein the base layer comprises polyethylene terephthalate, and optionally polybutylene terephthalate; and the top layer comprises low density polyethylene; wherein the multilayer film has a thickness of 80 G (20 μm) or less.

None of the prior art discloses the claimed multilayer film having the above-mentioned chemical resistance properties for a multilayer film having a thickness of 80 G (20 μm) or less.

### SUMMARY OF THE INVENTION

An embodiment relates to multilayer film having a low lamination temperature of film to metal substrate, wherein the multilayer film comprises a low density polyethylene (LDPE) as a bonding layer between the metal and polyethylene terephthalate (PET) base film, wherein the reduced lamination temperature helps to preserve the crystallinity of the PET base layer during lamination, thereby increasing chemical resistance and function of the PET in the LDPE/PET layer construction.

Another embodiment relates to a multilayer film having a high chemical resistance coating after lamination to metal substrate such that the multilayer film exhibits chemical resistance to low and high pH in a range of 1 to 13 pH. In the multilayer film, PET provides physical protection of the metal substrate used in can making and food packing, and LDPE provides robust bond layer that is not easily defeated by contents of container (i.e., Scrubbing Bubbles® cleaning liquid and/or Manwich® Sloppy Joe Sauce).

An embodiment relates to a multilayer film for food and non-food packaging applications, the multilayer film having chemical resistance to products having low to high pH from about 1 pH to about 13 pH, the multilayer film comprising a base layer and a top layer; wherein the base layer comprises polyethylene terephthalate, and optionally polybutylene terephthalate; and the top layer comprises low density polyethylene; wherein the multilayer film has a thickness of 80 G (20 μm) or less.

Other variations of the embodiment relate to:

The multilayer film, wherein the multilayer film has the thickness of about 60 G (15 μm) or less.

The multilayer film, wherein the top layer has a melt index of about 10 gm/10 min or less.

The multilayer film, further comprising a primer layer between the base layer and the top layer, wherein the primer layer comprises PEI.

The multilayer film, wherein the primer layer comprises 0.01 to 10 wt % of the PEI.

The multilayer film, wherein the primer layer comprises 4-6 wt % of the PEI.

An embodiment relates to a multilayer film comprising a base layer, a primer layer and a top layer in this order; wherein the base layer comprises 90-99.99 wt % of polyethylene terephthalate and 0.01-1 wt % silica; the primer layer comprises 0.01 to 10 wt % of PEI; and the top layer comprises 90-100 wt % low density polyethylene, wherein the multilayer film has a thickness of 80 G (20 μm) or less.

Other variations of the embodiment relate to:

The multilayer film, wherein the multilayer film has the thickness of about 60 G (15 μm) or less.

The multilayer film, wherein the top layer has a melt index of about 10 gm/10 min or less.

The multilayer film, wherein the top layer has the melt index of about 9 gm/10 min or less.

The multilayer film, wherein the top layer has the melt index of about 8 gm/10 min or less.

An embodiment relates to a multilayer film comprising a base layer, a primer layer and a top layer in this order; wherein the base layer comprises 60-99.99 wt % of polyethylene terephthalate, 20-40 wt % of polybutylene terephthalate and 0.01-1 wt % silica; the primer layer comprises PEI; and the top layer comprises 90-100 wt % low density polyethylene.

Other variations of the embodiment relate to:

The multilayer film, wherein the primer layer comprises 0.01 to 10 wt % of the PEI.

The multilayer film, wherein the primer layer comprises 4-6 wt % of the PEI.

An embodiment relates to a multilayer film comprising a base layer, an intermediate layer and a top layer in this order; wherein the base layer comprises 90-99.99 wt % of polyethylene terephthalate and 0.01-1 wt % silica; the intermediate layer comprises 90-100 wt % of isophthalic acid modified polyethylene terephthalate; and the top layer comprises 90-100 wt % low density polyethylene.

Other variations of the embodiment relate to:

The multilayer film, wherein the multilayer film has a thickness of 80 G (20 μm) or less.

The multilayer film, further comprising a primer layer between the intermediate layer and the top layer, wherein the primer layer comprises PEI.

An embodiment relates to a multilayer film comprising a base layer, an intermediate layer, a primer layer and a top layer in this order; wherein the base layer comprises 90-99.99 wt % of polyethylene terephthalate and 0.01-1 wt % silica; the intermediate layer comprises 40-60 wt % of polyethylene terephthalate and 40-60 wt % of amorphous copolyester; the primer layer comprises PEI; and the top layer comprises 90-100 wt % low density polyethylene.

Other variations of the embodiment relate to:

The multilayer film, wherein the multilayer film has a thickness of 80 G (20 μm) or less.

The multilayer film, wherein the primer layer comprises 0.01 to 10 wt % of the PEI.

### BRIEF DESCRIPTION OF DRAWINGS

Some embodiments of the invention and of the making and using the invention are described in the Detailed Description and the descriptions are to be read with reference to accompanying drawings presented below by the way of examples.

FIG. 1 shows the structure of the multilayer film of Example 1.

FIG. 2 shows the structure of the multilayer film of Example 2.

FIG. 3 shows the structure of the multilayer film of Example 3.

FIG. 4 shows the structure of the multilayer film of Example 4.

FIG. 5 shows the structure of the multilayer film of Example 5.

FIG. 6 shows the structure of the multilayer film of Example 6.

FIG. 7 shows the structure of the multilayer film of Example 7.

FIG. 8 shows the structure of the multilayer film of Example 8.

FIG. 9 shows the structure of the multilayer film of Example 9.

FIG. 10 shows the structure of the multilayer film of Example 10.

### DETAILED DESCRIPTION OF THE INVENTION

All publications, patents, and patent applications cited in this Specification are hereby incorporated by reference in their entirety.

The singular forms “a,” “an” and “the” are used herein to refer to one or to more than one (i.e., to at least one) of the grammatical object of the article. By way of example, “a component” means one component or more than one component.

Any ranges cited herein are inclusive.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

No element, act, or instruction used herein should be construed as critical or essential unless explicitly described as such. Also, as used herein, the articles “a” and “an” are intended to include items and may be used interchangeably with “one or more.” Furthermore, as used herein, the term “set” is intended to include items (e.g., related items, unrelated items, a combination of related items, and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

The present invention may be embodied in other specific forms without departing from its spirit or characteristics. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

Unless otherwise defined herein, scientific and technical terms used in connection with the present invention shall have the meanings that are commonly understood by those of ordinary skill in the art. Further, unless otherwise required by context, singular terms shall include pluralities and plural terms shall include the singular. Generally, nomenclatures used in connection with, and techniques of, the trash recycling methodologies described herein are those well-known and commonly used in the art.

Before the embodiments are described, it is to be understood that this disclosure is not limited to the particular processes, methods and devices described herein, as these may vary. It is also to be understood that the terminology used herein is for the purpose of describing the particular versions or embodiments only and is not intended to limit the scope of the present disclosure which will be limited only by the appended claims. Nothing in this disclosure is to be construed as an admission that the embodiments described in this disclosure are not entitled to antedate such disclosure by virtue of prior invention. As used in this document, the term “comprising” means “including, but not limited to.”

The term “low density polyethylene” typically refers to a polyethylene having a melting point from 100 to 115° C., a melt index between 4 and 20 g/10 min @190° C./2.16 kg, and a density from 0.910-0.930 g/cm³.

An embodiment relates to a multi-layer, biaxially oriented polyester (BOPET) film with an extrusion coated layer of LDPE for metal sheet lamination for food and non-food containers. An embodiment relates to a new multilayer polyester and polyethylene film that has a robust polyester layer along with a softer more chemically resistant polyethylene bond layer, which will aid in the protection of the container and adhesion of the film to the metal substrate, that can be laminated to metals used in the manufacture of food and non-food containers.

Multilayer Film

The can liner film may comprise one or more layers, optionally at least 2 layers. A multilayered can liner film may include one or more of each of: a can-side or inside layer (i.e., heat seal or metal bonding layer), an outside layer, a product contact layer. In addition, there may be one or more core layers between the layer bonded to the metal surface and the product contact side layer that is in direct contact with the food or chemicals stored inside the can.

An embodiment relates to a polyester film containing at least one layer of extrusion coated polyethylene, which can be laminated to a metal plate to used in the manufacture of can components. The metal substrate is typically tin-free steel (TFS), electro tin plated steel (ETP), or aluminum, with a dimensional change of no more than 2.0% after heat treatment of 210° C.

The base PET films that are the subjects of an embodiment are generally one, two, or three-layer coextruded and biaxially drawn structures. The outside and optional “skin” layers are lesser in thickness than that of the core layer. A layer of low density polyethylene (LDPE) is then extrusion coated onto the base PET film described above. This layer of LDPE in an embodiment (thereafter referred to as the bond layer), is essentially LDPE with a density of 0.910 to 0.920 g/cm3 and a melt index of 5 to 25 g/10 min at 190° C.

Thickness ranges for the base layer PET is between 8 and 50 microns and the LDPE bond layer thickness range is between 4 and 25 microns. Preferred thickness for the PET and LDPE are closer to 9 microns and 6 microns respectively. The LDPE layer thickness can be 100 microns or more but such high thicknesses aren't practical. Typical total thickness of final film article is 14 micron to 50 microns.

The resulting two-layer film structure is laminated onto a metal sheet (steel or aluminum) which is then formed into a can or can part. Both sides of the metal sheet can be laminated with plastic film but the films are laminated on the side that is intended to become the inside surface of the can and in such a way that the bond layer is in contact with the metal substrate and the base film layer is the product contact layer (i.e. the layer away from the metal).

The base film layer typically is made up of 1, 2, or 3 coextruded layers. These layers comprise of up to 100% PET resin (“base resin”), and up to 70% PBT resin, while also comprising an anti-block Masterbatch typically containing inorganic particles. Masterbatch addition levels in the base film layer range between 0.1 and 10 wt. %. The inorganic particles are for anti-blocking purposes and friction control. A typical inorganic particle composition is silica (silicon dioxide, SiO2) used in sizes ranging from <1 micron up to 10 microns. The silica particles are typically added during coextrusion in the form of a concentrate PET chip (“silica masterchip”) made by adding silica in the polymerization. Typical silica content in the silica masterchip is 1-3 wt. %; typical addition level of the silica masterchip in the base film layer is 1-15 wt %, resulting in net silica content around 0.1-3 wt. %. The base film layer can also have a layer of amorphous polymer which acts as a bonding layer between the LDPE and the PET. This amorphous bond layer comprises of a 1% to 19% Isophthalic acid polyester (IPET) polymer or from 1% to 99% polyethylene terephthalate copolymerized with cyclohexanedimethal (PETG).

Polyester Film Process

The PET film suitable for use in an embodiment is biaxially oriented prior to laminating it to the metal substrate. The films are biaxially oriented by conventional methods. Typically, a raw material PET resin is supplied in solid form to a melt processing device, e.g., a continuous screw extruder. The heating of the melt processor is controlled to maintain the PET resin above its melting point but below polymer degradation temperature. PET molten resin is extruded from an appropriately shaped die to form a thin, flat ribbon of polymer melt. The polymer ribbon is quenched in air and or on a chilled roll to form a solid, self-supporting film. The film is taken up by sets of rollers turning at different rotation speeds that stretch the film in the direction of continuous forward motion, referred to as the machine direction (“MD”). The stretching can be accompanied by heating of the film to establish crystal orientation in the MD. The mono-directionally oriented film is clamped at its opposite edges in and stretched in the transverse machine direction (“TD”) laterally perpendicular to the MD in a tenter oven. The tenter oven is heated to temperatures operative to establish crystal orientation in the TD thus forming a biaxially oriented PET film, e.g., a biaxially oriented PET film for use with an embodiment is stretched about 100%-400% in the MD and 100%-600% in the TD. The biaxially oriented film can be heat set at temperatures can be between about 300° F. and about 490° F., optionally about 350° F. to about 460° F.

Extrusion Coating Process

Once the biaxially oriented PET base film portion is produced, either the plain PET side of the film or the amorphous IPET polymer side is corona treated and coated with a primer coating (Mica® A-131-X from Mica Corp.) using a gravure coater. The primer coating is then dried in a convective drier. Once dried the LDPE is then extrusion coated onto the primer coated side.

Sample Preparation

Film Thermal Lamination Procedure onto Metal Sheet

Tin-Free Steel with a thickness of 0.0075″ was preheated to 400 F. The steel and film are passed through a set of nipped rolls forming the initial bond of film to steel. The film and steel laminate structure is then passed through a secondary heating operation at 425° F. for 20 seconds, then cooled to room temperature.

The film side laminated to steel was the side opposite that of the LDPE side (product contact side; base film side), i.e., the lamination side was side bonding layer.

Laminate Testing Method

The bond layer of the film is tested to determine if during a soak test that it might become delaminated from the tin free steel substrate it has been thermally laminated to. The samples for testing are prepared by first cutting a small 3″×3″ piece of tin free steel. Once cut, the steel is washed using a 10% solution of Metalnox® M6324R cleaner. The Metalnox® solution is sprayed onto the surface of the metal and spread with a paper towel. Once the metal sheet is coated in the Metalnox solution, deionized water is sprayed onto the surface of the metal sheet to rinse away the solution. The residual rinse water is wiped with a clean paper towel and the metal sheet is then placed inside a 120° C. oven for 5 minutes to bake off any residual moisture left on the surface of the metal. Once the sample is removed from the oven it is allowed to cool to room temperature. The sheet of film to be tested is placed bond layer facing down in direct contact with the metal sheet. Two small pieces of Scotch® tape are added to the top of the sample where the film and metal substrate meet to keep the film from sliding off during lamination. This also helps keep the film from sliding around when the sample is cut to the size of the metal sheet. Once the tape is in place, a razor blade is used to cut the film 1-2 mm inside from each remaining edge of the metal sheet. When complete, the sample is ready to be thermally laminated.

Using a ChemInstruments HL-200 hot roll laminator, the temperature is set to 470° F. and allowed to heat up to the temperature prior to lamination. The top roll of the hot roll laminator is the only heated roll. As such, the laminate sample is heated through the metal substrate and nipped between the heated roll and the bottom un-heated roll. On other words, place the sample to be laminated film side down so that the bare metal is against the heated upper roll. The laminator nip pressure is set to 70 psi and the motor speed is set to “1” (no units). When lamination is complete allow sample to cool to room temperature

Prior to chemical soak testing, the sample is impacted using a Gardco Universal Impact Tester model 172RF to represent the stresses that the film and substrate would be subjected to during forming steps at a can part manufacturer. The sample is impacted from the unlaminated side towards the laminated film side using the 2 lb, ⅝″ dropping weight with an additional 2 lb dropping weight added. Impact height is 2-4 cm depending on steel thickness. Once impacted all four corners of the sample are then folded towards the unlaminated side of the sample using a pair of needle nose pliers. Again, this step also represents more stresses that the laminate structure would experience during can making. Once the corners are folded and the impacting is complete, the sample is ready to be submerged in the desired soak test chemical such as Scrubbing Bubbles®.

Sample Soak Testing

A glass container large enough to hold the desired soak test chemical and the laminated sample is filled with the liquid test chemical. The laminated test sample is submerged completely submersed in the liquid and the container is placed into a 120° F. oven for the duration of the test. Samples are checked every 30 days for delamination. Total soak test time is up to 180 days or sample adhesion failure, whichever comes first.

### Materials Description

Toray Plastics (America), Inc. grade F21MP: A PET homo-polymer having an intrinsic viscosity (IV) of about 0.65, and a melting temperature (Tm) of 255° C.

Toray Plastics (America), Inc. grade F18 G: A silica masterbatch with a nominal diameter of 2.5p m loaded at 2% a in PET having an intrinsic viscosity (IV) of about 0.65, and a melting temperature (Tm) of 255° C.

Toray Plastics (America), Inc. grade F55M: A 19% isophthalic acid modified PET (IPET) homo-polymer having an intrinsic viscosity (IV) of about 0.69. IPET is a slow-crystallizing co-polyester resin (IV=0.69; Tm=205° C.) with 19:81 molar (=weight % in this case) parts combination of isophthalic/terephthalic acid reacted with ethylene glycol.

Toray Plastics (Malaysia), Sdn Bhd. grade 1200M: A PBT homo-polymer having an intrinsic viscosity (IV) of about 1.23, and a melting temperature (Tm) of 223° C.

Eastman Chemical Company grade Eastar™ 6763. An amorphous copolyester (PETG) with an intrinsic viscosity (IV) of about 0.75. PETG contains a dicarboxylic acid component comprising: (i) about 80 to about 100 mole % of terephthalic acid residues; (ii) about 0 to about 20 mole % of aromatic and/or aliphatic dicarboxylic acid residues having up to 20 carbon atoms.

Dow Plastics grade 722. A low density polyethylene homo-polymer (LDPE) with a melt index of about 8 g/10 min at 190° C./2.16 kg, and a melting temperature (Tm) of 105° C.

Chevron Phillips Marlex 1017. A low density polyethylene homo-polymer (LDPE) with a melt index of about 7 g/10 min at 190° C./2.16 kg, and a melting temperature (Tm) of 104° C.

Westlake Chemicals grade EC4042. A low density polyethylene homo-polymer (LDPE) with a melt index of about 10 g/10 min at 190° C./2.16 kg.

Primer: Mica Corp grade A-131-X primer. A water-based, modified polyethyleneimine (PEI) resin dispersion with 5% solids.

### Examples

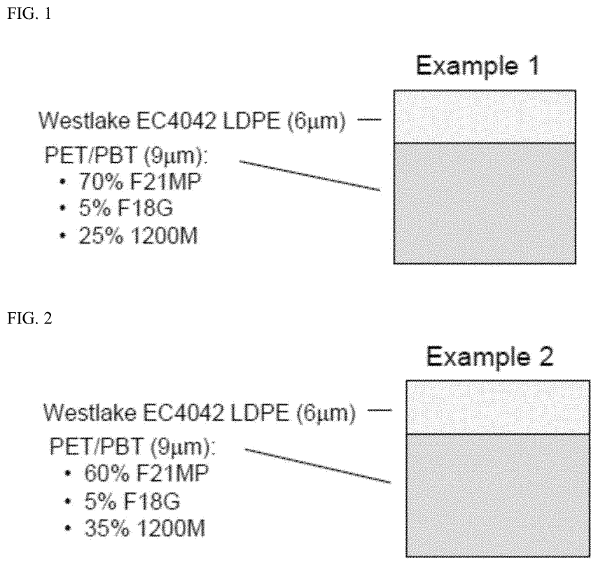

Example 1 (FIG. 1 and Table 1): A 9 μm biaxially oriented mono-layer base film comprising approximately 75% PET and 25% PBT, followed by 6 μm of extrusion coated Westlake EC4042 LDPE. This example has no primer layer between PET/PBT base film and LDPE.

TABLE 1
Composition of Example 1 (first column shows reference
structure; second column shows ingredient with trade names and
third to fifth column show chemical composition by ingredients).

| | | | | |
|---|---|---|---|---|
| Top Layer | Westlake | a low density | 100% LDPE | 100% LDPE |
| | EC4042 | polyethylene | (MI 10 g/10 | (MI 10 g/10 |
| | LDPE | homo-polymer | min) | min/) |
| | | (LDPE) with a | | |
| | | melt index (MI) | | |
| | | of about 10 g/10 | | |
| | | min | | |
| Base Layer | 75% PET | 60% PET | 70% PET | 74.9% PET |
| | (60% F21MP | homopolymer | 0.1% silica | 0.1% silica |
| | and 5% | and 5% silica | 4.9% PET | 25% PBT |
| | F18G) | masterbatch with | 25% PBT | |
| | 25% PBT | a nominal | | |
| | | diameter of | | |
| | | 2.5 μm loaded at | | |
| | | 2% a in PET | | |
| | | 35% PBT homo- | | |
| | | polymer | | |

Example 2 (FIG. 2 and Table 2): A 9 μm biaxially oriented mono-layer base film comprising approximately 65% PET and 35% PBT, followed by 6 μm of extrusion coated Westlake EC4042 LDPE. This example has no primer layer between PET/PBT base film and LDPE.

TABLE 2
Composition of Example 2 (first column shows reference
structure; second column shows ingredient with trade names and
third to fifth column show chemical composition by ingredients).

| | | | | |
|---|---|---|---|---|
| Top Layer | Westlake | a low density | 100% LDPE | 100% LDPE |
| | EC4042 | polyethylene | (MI 10 g/10 | (MI 10 g/10 |
| | LDPE | homo-polymer | min) | min/) |
| | | (LDPE) with a | | |
| | | melt index (MI) | | |
| | | of about 10 g/10 | | |
| | | min | | |
| Base Layer | 65% PET | 60% PET | 60% PET | 64.9% PET |
| | (60% F21MP | homopolymer | 0.1% silica | 0.1% silica |
| | and 5% | and 5% silica | 4.9% PET | 35% PBT |
| | F18G) | masterbatch with | 35% PBT | |
| | 35% PBT | a nominal | | |
| | | diameter of | | |
| | | 2.5 μm loaded at | | |
| | | 2% a in PET | | |
| | | 35% PBT homo- | | |
| | | polymer | | |

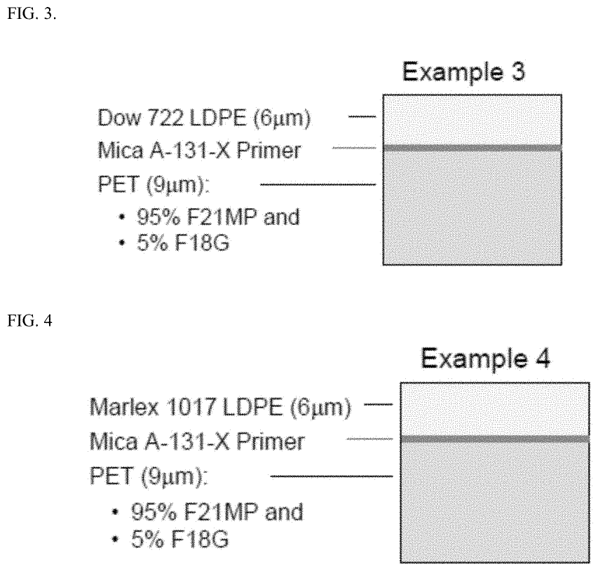

Example 3 (FIG. 3 and Table 3′): A 9 μm biaxially oriented mono-layer PET base film coated with about 0.025 lb/ream of Mica® A-131-X primer followed by 6 μm of extrusion coated Dow 722 LDPE.

TABLE 3
Composition of Example 3 (first column shows reference
structure; second column shows ingredient with trade names and
third to fifth column show chemical composition by ingredients).

| | | | | |
|---|---|---|---|---|
| Top Layer | Dow 722 | a low density | 100% LDPE | 100% LDPE |
| | LDPE | polyethylene | (MI 8 g/10 | (MI 8 g/10 |
| | | homo-polymer | min) | min/) |
| | | (LDPE) with a | | |
| | | melt index (MI) | | |
| | | of about 8 g/10 | | |
| | | min | | |
| Primer | Mica ® A- | A water-based, | 5% PEI | 5% PEI |
| Layer | 131-X primer | modified | 95% water | 95% water |
| | | polyethylenimine | | |
| | | (PEI) resin | | |
| | | dispersion with | | |
| | | 5% solids | | |
| Base Layer | PET (95% | 95% PET | 95% PET | 99.9% PET |
| | F21MP, 5% | homopolymer | 0.1% silica | 0.1% silica |
| | F18G) | and 5% silica | 4.9% PET | |
| | | masterbatch with | | |
| | | a nominal | | |
| | | diameter of 2.5 | | |
| | | μm loaded at 2% | | |
| | | a in PET | | |

Example 4 (FIG. 4 and Table 4): A 9 μm biaxially oriented mono-layer PET base film coated with about 0.025 lb/ream of Mica® A-131-X primer followed by 6 μm of extrusion coated Marlex 1017 LDPE.

TABLE 4
Composition of Example 4 (first column shows reference
structure; second column shows ingredient with trade names and
third to fifth column show chemical composition by ingredients).

| | | | | |
|---|---|---|---|---|
| Top Layer | Marlex 1017 | a low density | 100% LDPE | 100% LDPE |
| | LDPE | polyethylene | (MI 7 g/10 | (MI 7 g/10 |
| | | homo-polymer | min) | min/) |
| | | (LDPE) with a | | |
| | | melt index (MI) | | |
| | | of about 7 g/10 | | |
| | | min | | |
| Primer | Mica ® A- | A water-based, | 5% PEI | 5% PEI |
| Layer | 131-X primer | modified | 95% water | 95% water |
| | | polyethylenimine | | |
| | | (PEI) resin | | |
| | | dispersion with | | |
| | | 5% solids | | |
| Base Layer | PET (95% | 95% PET | 95% PET | 99.9% PET |
| | F21MP, 5% | homopolymer | 0.1% silica | 0.1% silica |
| | F18G) | and 5% silica | 4.9% PET | |
| | | masterbatch with | | |
| | | a nominal | | |
| | | diameter of 2.5 | | |
| | | μm loaded at 2% | | |
| | | a in PET | | |

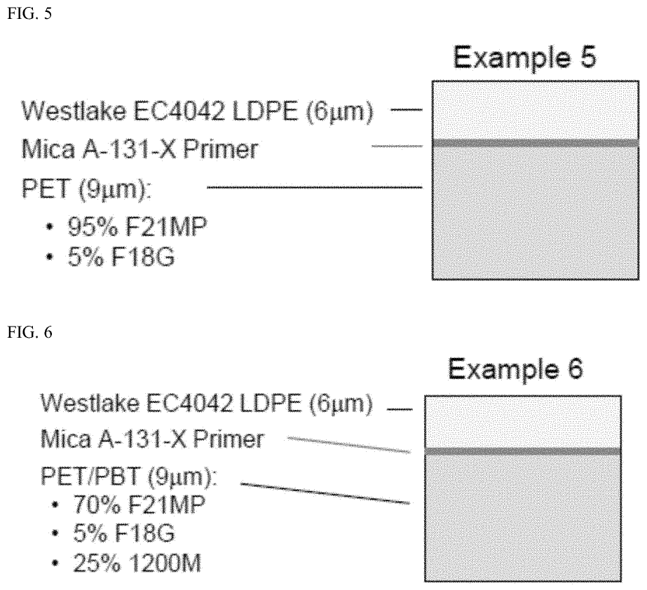

Example 5 (FIG. 5 and Table 5′): A 9 μm biaxially oriented mono-layer PET base film coated with about 0.025 lb/ream of Mica® A-131-X primer followed by 6 μm of extrusion coated Westlake EC4042 LDPE.

TABLE 5
Composition of Example 5 (first column shows reference
structure; second column shows ingredient with trade names and
third to fifth column show chemical composition by ingredients).

| | | | | |
|---|---|---|---|---|
| Top Layer | Westlake | a low density | 100% LDPE | 100% LDPE |
| | EC4042 | polyethylene | (MI 10 g/10 | (MI 10 g/10 |
| | LDPE | homo-polymer | min) | min/) |
| | | (LDPE) with a | | |
| | | melt index (MI) | | |
| | | of about 10 g/10 | | |
| | | min | | |
| Primer | Mica ® A- | A water-based, | 5% PEI | 5% PEI |
| Layer | 131-X primer | modified | 95% water | 95% water |
| | | polyethylenimine | | |
| | | (PEI) resin | | |
| | | dispersion with | | |
| | | 5% solids | | |
| Base Layer | PET (95% | 95% PET | 95% PET | 99.9% PET |
| | F21MP, 5% | homopolymer | 0.1% silica | 0.1% silica |
| | F18G) | and 5% silica | 4.9% PET | |
| | | masterbatch with | | |
| | | a nominal | | |
| | | diameter of 2.5 | | |
| | | μm loaded at 2% | | |
| | | a in PET | | |

Example 6 (FIG. 6 and Table 6): A 9 μm biaxially oriented mono-layer base film comprising approximately 75% PET and 250 PBT, coated with about 0.025 lb/ream of Mica® A-131-X primer followed by 6 μm of extrusion coated Westlake EC4042 LDPE.

TABLE 6
Composition of Example 6 (first column shows reference
structure; second column shows ingredient with trade names and
third to fifth column show chemical composition by ingredients).

| | | | | |
|---|---|---|---|---|
| Top Layer | Westlake | a low density | 100% LDPE | 100% LDPE |
| | EC4042 | polyethylene | (MI 10 g/10 | (MI 10 g/10 |
| | LDPE | homo-polymer | min) | min/) |
| | | (LDPE) with a | | |
| | | melt index (MI) | | |
| | | of about 10 g/10 | | |
| | | min | | |
| Primer | Mica ® A- | A water-based, | 5% PEI | 5% PEI |
| Layer | 131-X primer | modified | 95% water | 95% water |
| | | polyethylenimine | | |
| | | (PEI) resin | | |
| | | dispersion with | | |
| | | 5% solids | | |
| Base Layer | 75% PET | 60% PET | 70% PET | 74.9% PET |
| | (60% F21MP | homopolymer | 0.1% silica | 0.1% silica |
| | and 5% | and 5% silica | 4.9% PET | 25% PBT |
| | F18G) | masterbatch with | 25% PBT | |
| | 25% PBT | a nominal | | |
| | | diameter of | | |
| | | 2.5 μm loaded at | | |
| | | 2% a in PET | | |
| | | 35% PBT homo- | | |
| | | polymer | | |

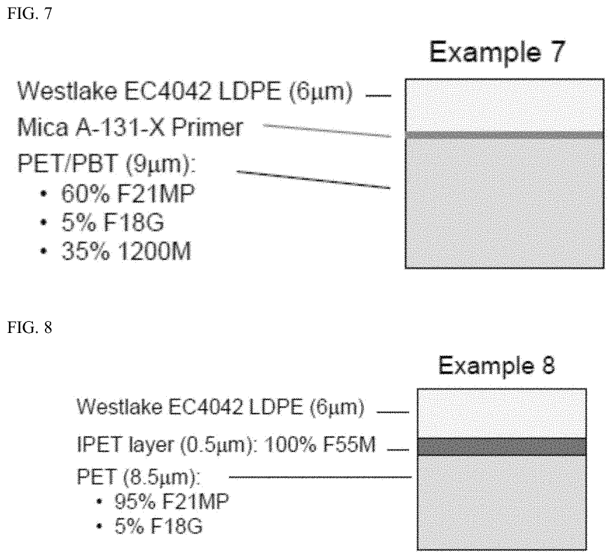

Example 7 (FIG. 7 and Table 7): A 9 μm biaxially oriented mono-layer base film comprising approximately 65% PET and 35 PBT, coated with about 0.025 lb/ream of Mica® A-131-X primer followed by 6 μm of extrusion coated Westlake EC4042 LDPE.

TABLE 7
Composition of Example 7 (first column shows reference
structure; second column shows ingredient with trade names and
third to fifth column show chemical composition by ingredients).

| | | | | |
|---|---|---|---|---|
| Top Layer | Westlake | a low density | 100% LDPE | 100% LDPE |
| | EC4042 | polyethylene | (MI 10 g/10 | (MI 10 g/10 |
| | LDPE | homo-polymer | min) | min/) |
| | | (LDPE) with a | | |
| | | melt index (MI) | | |
| | | of about 10 g/10 | | |
| | | min | | |
| Primer | Mica ® A- | A water-based, | 5% PEI | 5% PEI |
| Layer | 131-X primer | modified | 95% water | 95% water |
| | | polyethylenimine | | |
| | | (PEI) resin | | |
| | | dispersion with | | |
| | | 5% solids | | |
| Base Layer | 65% PET | 60% PET | 60% PET | 64.9% PET |
| | (60% F21MP | homopolymer | 0.1% silica | 0.1% silica |
| | and 5% | and 5% silica | 4.9% PET | 35% PBT |
| | F18G) | masterbatch with | 35% PBT | |
| | 35% PBT | a nominal | | |
| | | diameter of | | |
| | | 2.5 μm loaded at | | |
| | | 2% a in PET | | |
| | | 35% PBT homo- | | |
| | | polymer | | |

Example 8 (FIG. 8 and Table 8): A 2-layer, 9 μm biaxially oriented PET base film coated with 6 μm of Westlake EC4042 LDPE extrusion coated onto the IPET side. This example has no primer layer between TPET layer of the base film and LDPE

TABLE 8
Composition of Example 8 (first column shows reference
structure; second column shows ingredient with trade names and
third to fifth column show chemical composition by ingredients).

| | | | | |
|---|---|---|---|---|
| Top Layer | Westlake | a low density | 100% LDPE | 100% LDPE |
| | EC4042 | polyethylene | (MI 10 g/10 | (MI 10 g/10 |
| | LDPE | homo-polymer | min) | min/) |
| | | (LDPE) with a | | |
| | | melt index (MI) | | |
| | | of about 10 | | |
| | | g/10 min | | |
| Intermediate | IPET | 19% isophthalic | 100% IPET | 100% IPET |
| Layer | | acid modified | | |
| | | PET homo- | | |
| | | polymer | | |
| | | (100%) | | |
| Base Layer | PET (95% | 95% PET | 95% PET | 99.9% PET |
| | F21MP, 5% | homopolymer | 0.1% silica | 0.1% silica |
| | F18G) | and 5% silica | 4.9% PET | |
| | | masterbatch | | |
| | | with a nominal | | |
| | | diameter of 2.5 | | |
| | | μm loaded at | | |
| | | 2% a in PET | | |

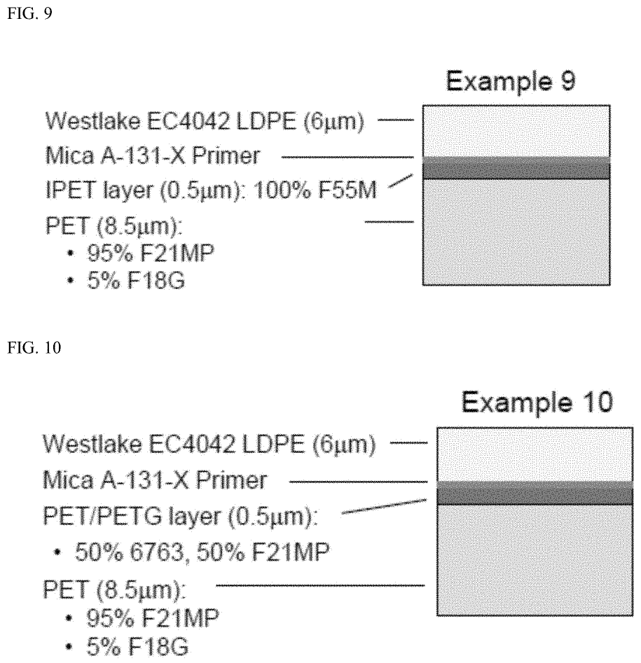

Example 9 (FIG. 9 and Table 9): A 2-layer, 9 μm biaxially oriented PET base film coated with about 0.025 lb/ream of Mica® A-131-X primer onto the IPET side, followed by 6 μm of extrusion coated Westlake EC4042 LDPE.

TABLE 9
Composition of Example 9 (first column shows reference
structure; second column shows ingredient with trade names and
third to fifth column show chemical composition by ingredients).

| | | | | |
|---|---|---|---|---|
| Top Layer | Westlake | a low density | 100% LDPE | 100% |
| | EC4042 | polyethylene | (MI 10 g/10 | LDPE |
| | LDPE | homo-polymer | min) | (MI 10 |
| | | (LDPE) with a | | g/10 |
| | | melt index (MI) | | min/) |
| | | of about 10 g/10 | | |
| | | min | | |
| Primer | Mica ® | A water-based, | 5% PEI | 5% PEI |
| Layer | A-131- | modified | 95% water | 95% |
| | X primer | polyethylenimine | | water |
| | | (PEI) resin | | |
| | | dispersion with | | |
| | | 5% solids | | |
| Intermediate | IPET | 19% isophthalic | 100% IPET | 100% |
| Layer | | acid modified | | IPET |
| | | PET homo- | | |
| | | polymer (100%) | | |
| Base Layer | PET (95% | 95% PET | 95% PET | 99.9% |
| | F21MP, | homopolymer | 0.1% silica | PET |
| | 5% | and 5% silica | 4.9% PET | 0.1% |
| | F18G) | masterbatch with | | silica |
| | | a nominal | | |
| | | diameter of 2.5 | | |
| | | μm loaded at 2% | | |
| | | a in PET | | |

Example 10 (FIG. 10 and Table 10): A 2-layer, 9 μm biaxially oriented PET base film coated with about 0.025 lb/ream of Mica® A A-131-X primer onto the PET/PETG side, followed by 6 μm of extrusion coated Westlake EC4042 LDPE.

TABLE 10
Composition of Example 10 (first column shows reference
structure; second column shows ingredient with trade names and
third to fifth column show chemical composition by ingredients).

| | | | | |
|---|---|---|---|---|
| Top Layer | Westlake | a low density | 100% LDPE | 100% |
| | EC4042 | polyethylene | (MI 10 g/10 | LDPE |
| | LDPE | homo-polymer | min) | (MI 10 |
| | | (LDPE) with a | | g/10 |
| | | melt index (MI) | | min/) |
| | | of about 10 g/10 | | |
| | | min | | |
| Primer | Mica ® | A water-based, | 5% PEI | 5% PEI |
| Layer | A-131- | modified | 95% water | 95% |
| | X primer | polyethylenimine | | water |
| | | (PEI) resin | | |
| | | dispersion with | | |
| | | 5% solids | | |
| Intermediate | PETG/PET | 50% PETG, | 50% PETG | 50% |
| Layer | (50% 6763, | 50%PET | 50% PET | PETG |
| | 50% | homopolymer | | 50% |
| | F21MP) | | | PET |
| Base Layer | PET (95% | 95% PET | 95% PET | 99.9% |
| | F21MP, | homopolymer | 0.1% silica | PET |
| | 5% | and 5% silica | 4.9% PET | 0.1% |
| | F18G) | masterbatch with | | silica |
| | | a nominal | | |
| | | diameter of 2.5 | | |
| | | μm loaded at 2% | | |
| | | a in PET | | |

The compositions of the chemical ingredients in the top layer, the intermediate layer, the primer layer and the base layer of Examples 1-10 are shown in Table 11.

TABLE 11
Compositions of the chemical ingredients in the top layer,
the intermediate layer, the primer layer and the base layer of Examples 1-10.

| Example | | | | | | | | | | |
|---|---|---|---|---|---|---|---|---|---|---|
| 1 | 2 | 3 | 4 | 5 | 6 | 7 | 8 | 9 | 10 | Range |

Top Layer: Ingredients and amounts by Wt %

| | | | | | | | | | | | |
|---|---|---|---|---|---|---|---|---|---|---|---|
| LDPE (MI | 0 | 0 | 0 | 100 | 0 | 0 | 0 | 0 | 0 | 0 | 0 to 100 |
| 7 g) | | | | | | | | | | | |
| LDPE (MI | 0 | 0 | 100 | 0 | 0 | 0 | 0 | 0 | 0 | 0 | 0 to 100 |
| 8 g) | | | | | | | | | | | |
| LDPE (MI | 100 | 100 | 0 | 0 | 100 | 100 | 100 | 100 | 100 | 100 | 0 to 100 |
| 10 g) | | | | | | | | | | | |

MI refers to Melt Index in gm per 10 min
Primer Layer: Ingredients and amounts by Wt %

| | | | | | | | | | | | |
|---|---|---|---|---|---|---|---|---|---|---|---|
| PEI | 0 | 0 | 5 | 5 | 5 | 5 | 5 | 0 | 5 | 5 | 0 to 5 |
| Water | 0 | 0 | 95 | 95 | 95 | 95 | 95 | 0 | 95 | 95 | 0 to 95 |

Intermediate Layer: Ingredients and amounts by Wt %

| | | | | | | | | | | | |
|---|---|---|---|---|---|---|---|---|---|---|---|
| PET | 0 | 0 | 0 | 0 | 0 | 0 | 0 | 0 | 0 | 50 | 0 to 50 |
| IPET | 0 | 0 | 0 | 0 | 0 | 0 | 0 | 100 | 100 | 0 | 0 to 100 |
| PETG | 0 | 0 | 0 | 0 | 0 | 0 | 0 | 0 | 0 | 50 | 0 to 50 |

Base Layer: Ingredients and amounts by Wt %

| | | | | | | | | | | | |
|---|---|---|---|---|---|---|---|---|---|---|---|
| PET | 74.9 | 64.9 | 99.9 | 99.9 | 99.9 | 74.9 | 64.9 | 99.9 | 99.9 | 99.9 | 64.9 to 99.9 |
| Silica | 0.1 | 0.1 | 0.1 | 0.1 | 0.1 | 0.1 | 0.1 | 0.1 | 0.1 | 0.1 | 0.1 |
| PBT | 25 | 35 | 0 | 0 | 0 | 25 | 35 | 0 | 0 | 0 | 0 to 35 |

1. A can liner comprising a laminated metal sheet comprising a tin-free metal sheet and a multilayer film comprising a base layer and a top layer; wherein the base layer comprises 60-99.99 wt % of polyethylene terephthalate, 20-40 wt % of polybutylene terephthalate and 0.01-1 wt % silica; and the top layer comprises 90-100 wt % low density polyethylene having a thickness of about 6 μm or less; wherein the multilayer film has a thickness of 80 G (20 μm) or less.

2. The can liner of claim 1, wherein the multilayer film has the thickness of about 60 G (15 μm) or less.

3. The can liner of claim 2, wherein the top layer has a melt index of about 10 gm/10 min or less.

4. The can liner of claim 1, further comprising a primer layer between the base layer and the top layer, wherein the primer layer comprises polyethylenimine.

5. (canceled)

6. (canceled)

7. A can liner comprising a laminated metal sheet comprising a tin-free metal sheet and a multilayer film comprising a base layer, a primer layer and a top layer in this order; wherein the base layer comprises 90-99.99 wt % of polyethylene terephthalate and 0.01-1 wt % silica; the primer layer comprises polyethylenimine; and the top layer comprises 90-100 wt % low density polyethylene having a thickness of about 6 μm or less, wherein the multilayer film has a thickness of 80 G (20 μm) or less.

8. The can liner of claim 7, wherein the multilayer film has the thickness of about 60 G (15 μm) or less.

9. The can liner of claim 8, wherein the top layer has a melt index of about 10 gm/10 min or less.

10. The can liner of claim 9, wherein the top layer has the melt index of about 9 gm/10 min or less.

11. The can liner of claim 10, wherein the top layer has the melt index of about 8 gm/10 min or less.

12. A can liner comprising a laminated metal sheet comprising a tin-free metal sheet and a multilayer film comprising a base layer, a primer layer and a top layer in this order; wherein the base layer comprises 60-99.99 wt % of polyethylene terephthalate, 20-40 wt % of polybutylene terephthalate and 0.01-1 wt % silica; the primer layer comprises polyethylenimine; and the top layer comprises 90-100 wt % low density polyethylene having a thickness of about 6 μm or less.

13. The can liner of claim 12, wherein the multilayer film has a thickness of 80 G (20 μm) or less.

14. The can liner of claim 13, wherein the multilayer film has the thickness of about 60 G (15 μm) or less.

15. A can liner comprising a laminated metal sheet comprising a tin-free metal sheet and a multilayer film comprising a base layer, an intermediate layer and a top layer in this order; wherein the base layer comprises 90-99.99 wt % of polyethylene terephthalate and 0.01-1 wt % silica; the intermediate layer comprises 90-100 wt % of isophthalic acid modified polyethylene terephthalate; and the top layer comprises 90-100 wt % low density polyethylene having a thickness of about 6 μm or less.

16. The can liner of claim 15, wherein the multilayer film has a thickness of 80 G (20 μm) or less.

17. The can liner of claim 15, further comprising a primer layer between the intermediate layer and the top layer, wherein the primer layer comprises polyethylenimine.

18. A can liner comprising a laminated metal sheet comprising a tin-free metal sheet and a multilayer film comprising a base layer, an intermediate layer, a primer layer and a top layer in this order; wherein the base layer comprises 90-99.99 wt % of polyethylene terephthalate and 0.01-1 wt % silica; the intermediate layer comprises 40-60 wt % of polyethylene terephthalate and 40-60 wt % of amorphous copolyester; the primer layer comprises polyethylenimine; and the top layer comprises 90-100 wt % low density polyethylene having a thickness of about 6 μm or less.

19. The can liner of claim 18, wherein the multilayer film has a thickness of 80 G (20 μm) or less.

20. The can liner of claim 19, wherein the multilayer film has the thickness of about 60 G (15 μm) or less.

21. The can liner of claim 7, wherein the top layer has a melt index of about 10 gm/10 min or less and the low density polyethylene has a thickness of about 4-6 μm.

22. The can liner of claim 12, wherein the top layer has a melt index of about 10 gm/10 min or less and the low density polyethylene has a thickness of about 4-6 μm.
